(19) United States
(12) Patent Application Publication
(10) Pub. No.: US 2012/0157229 A1
(43) Pub. Date: Jun. 21, 2012

(54) GOLF CLUB HEAD AND METHOD OF MANUFACTURING THEREOF

(75) Inventor: Takaharu TAKECHI, Tokyo (JP)

(73) Assignee: BRIDGESTONE SPORTS CO., LTD., Tokyo (JP)

(21) Appl. No.: 13/329,540

(22) Filed: Dec. 19, 2011

(30) Foreign Application Priority Data
Dec. 20, 2010 (JP) 2010-283325

(51) Int. Cl. A63B 53/04; B23P 17/00

(52) U.S. Cl. 473/345; 29/428

(57) ABSTRACT

A clubhead of a golf club which is a metallic hollow clubhead includes: a face portion; a crown portion; a hosel portion; and a lower part including a sole portion and side portions, wherein: the hosel portion and the crown portion are welded to the lower part; and the lower part is pressed out of a material plate and is thereafter subjected to a chemical polishing so that a thickness of the lower part varies by position.

### BACKGROUND

1. Field of the Invention

The present invention relates to a metallic hollow clubhead of a golf club and a method of manufacturing thereof and more particularly to a clubhead of a golf club which has a shape of a clubhead of a wood golf club or a shape resembling the shape of the wood golf club clubhead and a method of manufacturing thereof.

2. Description of the Related Art

Hollow metallic clubheads of wood golf clubs are widely used as clubheads of drivers or fairway woods. In general, a hollow clubhead of a wood golf club has a face portion which hits a ball, a crown portion which constitutes an upper surface portion of the clubhead, a sole portion which constitutes a bottom surface portion of the clubhead, toe-side and heel-side side surface portions of the clubhead, and a hosel portion. A shaft is inserted into the hosel portion of the clubhead and is fixed in place therein with an adhesive. In addition, in these days, many golf clubs called utility golf clubs are commercially sold, and as one type of such utility golf clubs, utility golf clubs are commercially sold which have various types clubheads which resemble the clubhead of the wood golf club (that is, the clubhead having the face portion, the sole portion, the side portions, the crown portion, and the hosel portion).

Aluminum alloy, stainless steel and titanium alloy are used as a metal of which the hollow clubhead is made, and in particular, titanium alloy is widely used in recent years. As a method of manufacturing such a metallic hollow clubhead, a method is known which comprises the steps of welding a face member to a lower part which has a sole portion and side portions, next, welding a hosel member to the lower part, next, welding a crown member to the lower part, and thereafter, subjecting the lower part to which the respective members are welded to finishing work (for example, JP-A-2003-265658). These parts are formed through forging or pressing (paragraph 0023 in JP-A-2003-265658).

There are situations in which a projecting portion or a recess portion is formed at the sole portion or the side portions so as to increase the modulus of section or to improve the design properties. When the lower part having those projecting portions or recess portions is pressed out of a material plate, a thickness of a portion lying near the projecting portion or the recess portion tends to be smaller than a thickness of a flat surface other than the projecting portion or the recess portion. Stress is concentrated to the projecting portion or the recess portion at the time of impact (immediately the ball is hit). Therefore, when the thickness of the projecting portion or the recess portion is small as is described above, there are fears that the properties of the clubhead are reduced.

### SUMMARY

An object of the invention is to provide a clubhead of a golf club which has a lower part over which the thickness distribution is controlled and a method of manufacturing of the same clubhead.

An object of one aspect of the invention is to provide a clubhead of a golf club in which a thickness of a projecting portion or a recess portions is made larger than a thickness of a central area of a sole portion.

According to a first aspect of the invention, there is provided a clubhead of a golf club which is a metallic hollow clubhead including: a face portion; a crown portion; a hosel portion; and a lower part including a sole portion and side portions, wherein: the hosel portion and the crown portion are welded to the lower part; and the lower part is pressed out of a material plate and is thereafter subjected to a chemical polishing so that a thickness of the lower part varies by position.

According to a second aspect of the invention, there is provided a clubhead of a golf club according to the first aspect, wherein a projecting portion or a recess portion is provided at the sole portion, and wherein a thickness of the lower part at the projecting portion or the recess portion is larger than a thickness of the lower part at a central area of the sole portion.

According to a third aspect of the invention, there is provided a clubhead of a golf club according to the second aspect, wherein the thickness of the lower part at the projecting portion or the recess portion is larger by 0.1 to 1.0 mm than the thickness of the lower part at the central area of the sole portion.

According to a fourth aspect of the invention, there is provided a clubhead of a golf club according to any of the first to third aspects, wherein the thickness of the central area of the sole portion is smaller by not less than 0.2 mm than thicknesses of portions of the sole portion which lie before and after the central area.

According to a fifth aspect of the invention, there is provided a clubhead of a golf club according to the first aspect, wherein a projecting portion or a recess portion is provided at the sole portion, and wherein a thickness of a corner edge portion of the projecting portion or the recess portion is larger than a thickness of a peripheral portion thereof.

According to a sixth aspect of the invention, there is provided a method of manufacturing of a clubhead of a golf club which is a metallic hollow clubhead having a face portion, a crown portion, a hosel portion, and a lower part including a sole portion and side portions, the hosel portion and the crown portion being welded to the lower part, including: manufacturing the lower part by pressing a lower part out of a material plate and thereafter subjecting the lower part to a chemical polishing so that a thickness of the lower part varies by position; welding the face portion to the lower part; and welding the hosel portion and the crown portion to the lower part and the face portion.

According to a seventh aspect of the invention, there is provided a method of manufacturing of a clubhead of a golf club according to the sixth aspect, wherein a thickness of the material plate of the lower part is in the range of 1.0 to 1.8 mm, wherein a projecting portion or a recess portion is formed through pressing, and wherein the lower part is subjected the chemical polishing so that a thickness of a central area of the sole portion is smaller by 0.1 to 1.0 mm than thicknesses of portions of the sole portion which lie before and after the central area.

According to an eighth aspect of the invention, there is provided a method of manufacturing of a clubhead of a golf club according to the sixth aspect, wherein a thickness of the material plate of the lower part is in the range of 1.0 to 1.8 mm, wherein a projecting portion or a recess portion is formed through pressing, and wherein a peripheral portion of the projecting portion or the recess portion is subjected to a chemical polishing so that a thickness of a corner edge portion of the projecting portion or the recess portion becomes larger than a thickness of the peripheral portion.

In the invention, the lower part whose thickness varies by position is manufactured by pressing the lower part out of the material plate and thereafter subjecting the lower part to the chemical polishing. Then, the face portion is welded to the lower part, and the crown portion and the hosel portion are welded to the lower part and the face portion.

In the lower part of the clubhead of the golf club according to the invention, the thickness distribution can be attained to the design value through chemical polishing, whereby the clubhead of the golf club can be provided which has the targeted properties.

According to the aspect of the invention, the thickness of the projecting portion or the recess portion of the lower part is increased, whereby the strength of the projecting portion or the recess portion can be ensured.

According to the different aspect of the invention, the thickness of the central area of the sole portion is made smaller than the thicknesses of the portions lying before and after the central area. By adopting this configuration, the ball hitting sound can be modified.

According to the further different aspect of the invention, the thickness of the corner edge portion of the projecting portion or the recess portion which is provided at the sole portion is made larger than the thickness of the periphery portion. By adopting this configuration, the strength of the corner edge portion is increased.

### BRIEF DESCRIPTION OF THE DRAWINGS

The present invention will become more fully understood from the detailed description given hereinbelow and the accompanying drawing which is given by way of illustration only, and thus is not limitative of the present invention and wherein:

FIG. 1 is a perspective view of a clubhead of a golf club according to an embodiment as seen from a sole side and a heel side.

FIG. 2 is a bottom view of the clubhead of the golf club according to the embodiment.

FIG. 3 is a bottom view of the clubhead of the golf club according to the embodiment.

FIG. 4 is a sectional view taken along the line IV-IV in FIG. 3.

FIG. 5A shows an exploded perspective view showing a method of manufacturing of the clubhead of the golf club according to the invention, and FIG. 5B shows a vertical sectional view of a face portion 40.

FIG. 6 is an exploded perspective view showing a method of manufacturing of a clubhead of a golf club according to another embodiment of the invention.

FIG. 7 is a bottom view of a clubhead of a golf club according to a further embodiment of the invention.

FIG. 8 is a bottom view of a clubhead of a golf club according to a different embodiment of the invention.

FIG. 9 is a sectional view taken along the line IX-IX in FIG. 8.

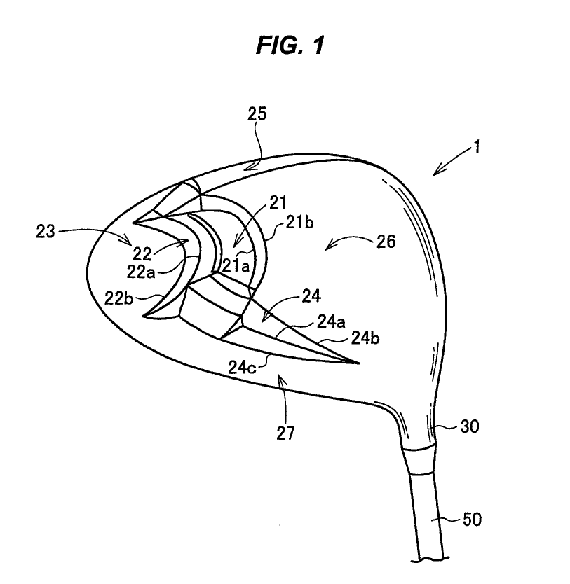

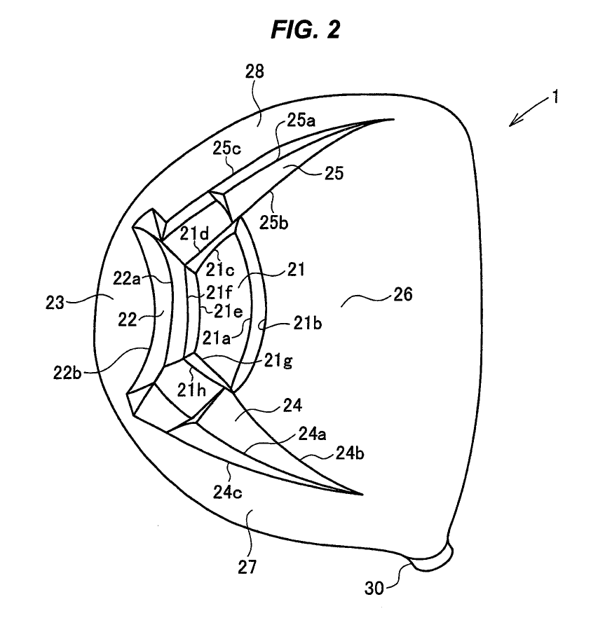

### DETAILED DESCRIPTION OF THE INVENTION

Hereinafter, referring to the drawings, clubheads of golf clubs according to embodiments of the invention and a method of manufacturing thereof will be described.

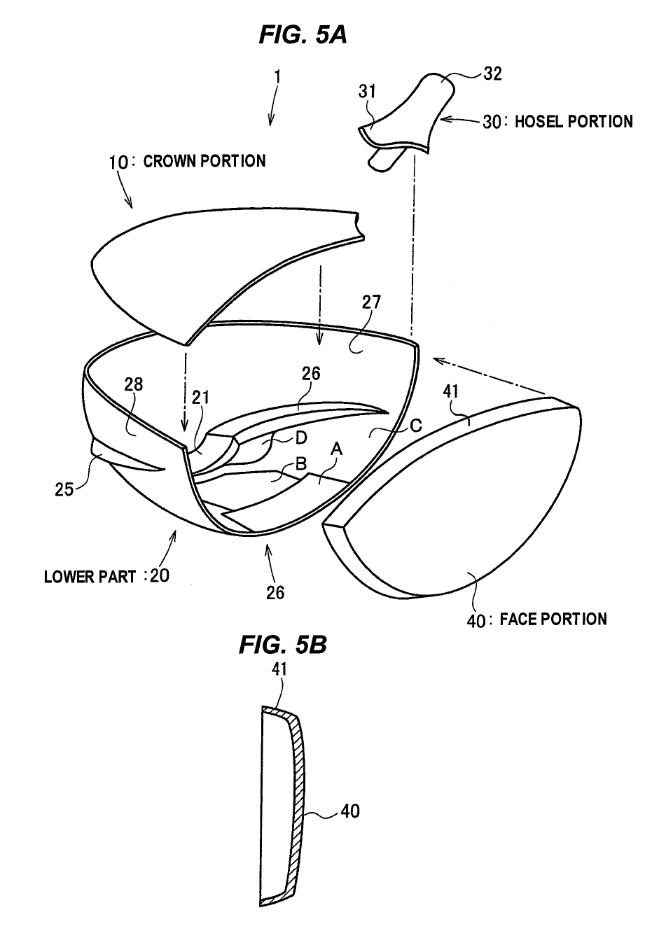

As is shown in FIGS. 5A and 5B, a clubhead 1 of a golf club includes a crown portion 10, a lower part 20, a hosel portion 30, and a face portion 40 which are welded integrally thereinto.

The hosel portion 30 has a bell-shaped skirt portion 31 and a column 32 which projects upwards and downwards from the skirt portion 31. A shaft 50 is inserted into the hosel portion 30 and is fixed in place therein with an adhesive. In this embodiment, the hosel portion 30 is provided so that a lower end of the column 32 does not reach the sole portion. However, the lower end of the column 32 may reach the sole portion.

These crown portion 10, lower part 20, hosel portion 30 and face portion 40 are individually made of titanium or a titanium alloy. As titanium or titanium alloys, materials having good cold working properties are preferable which include pure titanium, Ti-3AL-2.5V, Ti-1.5Al and the like. A material for the lower part 20 has desirably better cold working properties than Ti-6Al-4V which is normally used so that irregularities are easily formed on the lower part 20 to indicate a trade mark logo or a pattern.

In this embodiment, the clubhead 1 is a clubhead of a driver whose loft angle is in the range of 7 to 15°.

To weld the constituent parts of the clubhead 1, firstly, the crown portion 10 and the lower part 20 are spot welded so as to be temporarily held together. Following this, a circumferential edge portion of a frame-shaped circumferential wall portion 41 of the face portion 40 are temporarily held to the crown portion 10 and the lower part 20, and thereafter, a plasma welding is applied along the full circumference of the face portion 40.

Thereafter, the crown portion 10 and the lower part 20 are firmly secured to each other through Tig welding. Then, the hosel portion 30 is welded thereto.

However, this welding procedure is an example, and the invention is not limited to the welding procedure described above.

After the crown portion 10, the lower part 20, the hosel portion 30 and the face portion 40 are welded together in the way described above, various types of polishing and finishing such as painting are applied thereto so as to manufacture the clubhead 1 of the golf club as a final product.

Nest, the shape of the lower part 20 will be described.

A basin-shaped recess portion 21 is formed in the lower part 20 at a rear side of the sole portion and at a central portion with respect to a toe-to-heel direction. This recess portion 21 constitutes an area where a name plate is affixed by using a pressure sensitive adhesive double coated tape or the like. In addition, a second recess portion which recedes further than the recess portion 21 may be provided in the recess portion 21, so that a name plate is affixed to the second recess portion.

A projecting portion 22 extending in the toe-to-heel direction like a chain of mountains is formed at the rear of the recess portion 21. In the toe-to-heel direction, a central portion of this projecting portion 22 with respect to the toe-to-heel direction is positioned most forwards, while a toe-side portion and a heel-side portion of the projecting portion 22 are positioned most rearwards, whereby the projecting portion 22 is curved into an arc-like shape. A rear side of the projecting portion 22 constitutes a back portion (a back-side side portion) 23.

Projecting portions 24, 25, which project like a chain of mountains, are provided at a heel side and a toe side of the projecting portion 22, respectively, so as to extend forwards. A distance between the projecting portions 24, 25 increases as the projecting portions 24, 25 extend further towards a front side or a face side of the clubhead 1. The recess portion 21 is positioned between rear portions of the projecting portions 24, 25. A portion lying between the projecting portions 24, and further towards the face side than the recess portion 21 constitutes a flat sole main surface portion 26.

A portion lying closer to the heel side than the projecting portion 24 constitutes a heel-side side portion 27, and a portion lying closer to the toe side than the projecting portion 25 constitutes a toe-side side portion 28.

The recess portion 21 and the sole main surface portion are divided by a rising surface between a projecting elongated corner portion 21b and a recess elongated corner portion 21c.

A toe side, a back side and a heel side of the recess portion 21 are divided from the periphery thereof by a rising surface between a projecting elongated corner portion 21d and a recess elongated corner portion 21c, a rising surface between a projecting elongated corner portion 21f and a recess elongated corner portion 21e and a rising surface between a projecting elongated corner portion 21h and a recess elongated corner portion 21g, respectively. A height of these rising surfaces is preferably in the range of 2 to 5 mm and is more preferably in the range of 2.5 to 3.5 mm.

The projecting portions 22, 24, 25 have top ridge portions 22a, 24a, 25a, respectively. A recess elongated corner portion 22b is formed between the projecting portion 22 and the back portion 23. A recess elongated corner portion 24c is formed between the projecting portion 24 and the heel-side side portion 27, and a recess elongated corner portion 24b is formed between the projecting portion 24 and the sole main surface portion 26.

A recess elongated corner portion 25b is formed between the projecting portion 25 and the sole main surface portion 26, and a recess elongated corner portion 25c is formed between the projecting portion 25 and the toe-side side portion 28.

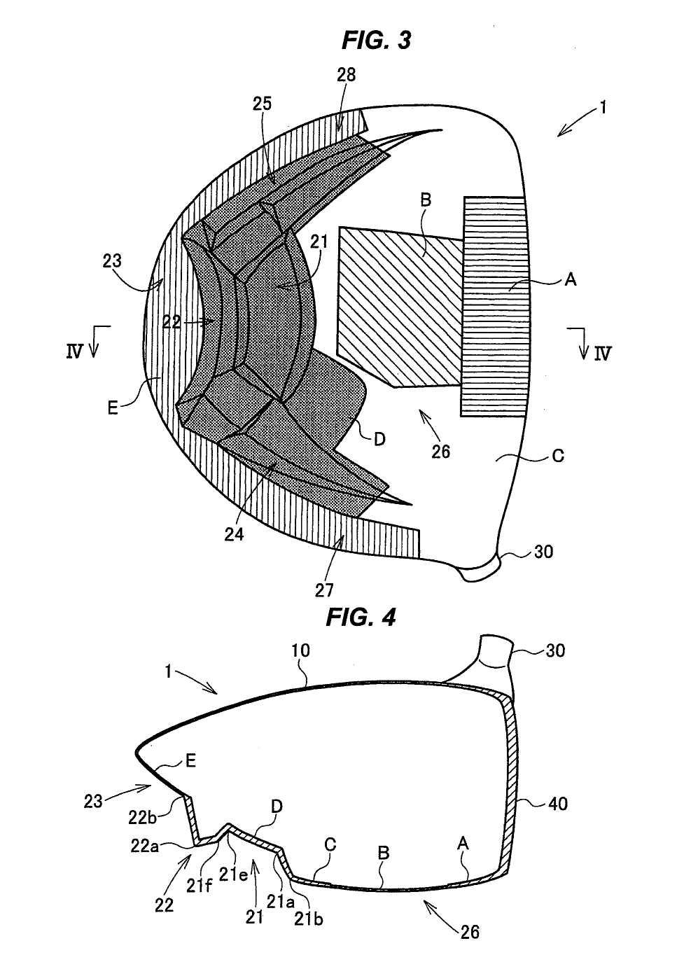

Next, the thickness distribution of the lower part 20 will be described by reference to FIGS. 3, 4.

In the sole surface, a thickness of a front central area A (an area shaded with horizontal lines in FIG. 3) which extends along the face portion is preferably in the range of 1.1 to 1.5 mm, is more preferably in the range of 1.2 to 1.4 mm and is most preferably about 1.3 mm.

A thickness of a central area B (an area shaded with diagonal lines in FIG. 3) of the sole main surface portion 26 which is continuous with the area A is preferably in the range of 0.6 to 0.75 mm and is more preferably in the range of 0.65 to 0.7 mm. The thickness of the central area B of the sole portion is preferably smaller by not less than 0.2 mm than the thicknesses of the area A and an area C which lie before and after it.

A thickness of an area D (an area shaded with fine dots in FIG. 3) which contains the recess portion 21, the projecting portion 22 and the rear portions of the projecting portions 24, is preferably in the range of 1.1 to 1.5 mm, is more preferably in the range of 1.2 to 1.4 mm and is most preferably about 1.3 mm. The area D extends to the front along the projecting portion 24 on the heel side, so that a weight material is screwed to be fixedly placed in this portion.

A thickness of an area E (an area shaded with vertical lines in FIG. 3) which extends from the back portion towards the toe-side and heel-side side portions is preferably in the range of 0.6 to 0.75 mm and is more preferably in the range of 0.65 to 0.7 mm. A thickness of the area C (an area shown left blank in FIG. 3) which lies between the areas A, B and the areas E, D is preferably in the range of 0.8 to 1.05 mm, is more preferably in the range of 0.8 to 1.0 mm and is most preferably about 0.9 mm.

Thicknesses at the projecting portions 22, 24, 25 and the recess portion 21 are preferably larger by 0.1 to 1.0 mm and more preferably larger by 0.4 to 0.7 mm than the thickness of the central area B of the sole main surface portion.

A length of the area A in the toe-to-heel direction is preferably in the range of 40 to 80 and is more preferably in the range of 50 to 60 mm. A length of the area A in a face-to-back direction is preferably in the range of 10 to 20 mm.

In addition, a thickness of the crown portion is preferably substantially equal to the thickness of the area E. A thickness of the face portion is preferably in the range of 1.5 to 5.0 mm and is more preferably in the range of 1.8 to 3.8 mm.

To manufacture this lower part 20, a lower part material plate is used which is thicker by a range of 0.1 to 0.2 mm than the thickness of the thickest area (in this embodiment, the areas A, D). This material plate is a flat plate having a uniform thickness. This material plate is pressed to form a recess portion 21 and projecting portions 22, 24, 25, whereby a lower part having a thickness equal to the thickness of the areas A, D is produced. Following this, this lower part is subjected to a chemical polishing so that the thicknesses of the areas B, C, E are reduced to respective target values.

The chemical polishing is a series of operations of masking portions of the lower part other than those where the thickness of the lower part is attempted to be reduced with an acid resistant paint and submerging the lower part in a chemical polishing liquid so that the relevant portions are dissolved from the surface to reduce the thickness of the lower part at those portions. A chemical polishing liquid used is preferably solutions of a mixture of nitric acid and hydrofluoric acid. Among those solutions, preferable is a solution of a mixture of 10 to 20 wt % of nitric acid and 10 to 20 wt % of hydrofluoric acid. However, when an electropolishing is used in parallel, one or two or more other kinds of acids can be used as required. For example, sulfuric acid, hydrochloric acid and oxalic acid can be used solely or in combination.

In the clubhead of the golf club which is configured as has been described heretofore, the recess portion and the projecting portions are formed through pressing the material plate and the thicknesses are adjusted through the chemical polishing performed after the pressing of the material plate, whereby the lower part 20 is manufactured. Therefore, the shape and the thickness distribution of the lower part can be attained as designed.

In this embodiment, the thicknesses at the projecting portions 22, 24, 25 and the recess portion 21 are made larger by 0.2 to 0.6 mm than the thickness of the central area B of the sole main surface portion. This increases the strength of the lower part 20 at the projecting portions 22, 24, 25 and the recess portion 21. In addition, the thicker area A and the thicker areas C, D are disposed before and after the central area B of the sole main surface portion, respectively. Therefore, the number of vibrations near the area B is increased at the time of impact, whereby the ball hitting sound is modified.

In this embodiment, the thickness of the clubhead 1 is reduced at the area E in the lower part 20 and the crown portion, and this lowers the center of gravity of the clubhead 1. In addition, the crown portion easily deflects at the time of impact, and this enables the ball to be hit to fly at a higher angle.

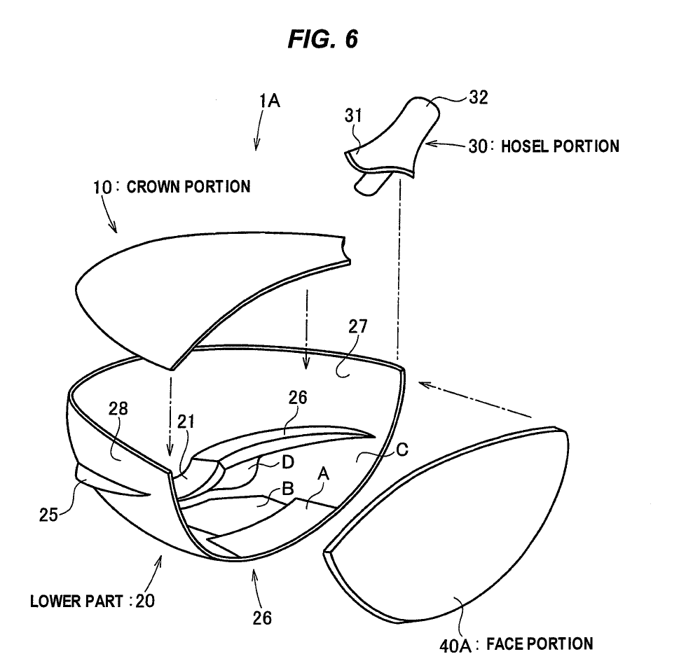

In the embodiment described above, the face portion 40 is formed into the cup shape having the frame-like circumferential wall portion 41 which is erected to the rear from a circumferential edge of the face surface. However, the face portion may have a plate-like shape which constitutes only a face surface as with a face portion 40A of a clubhead 1A of a golf club shown in FIG. 6.

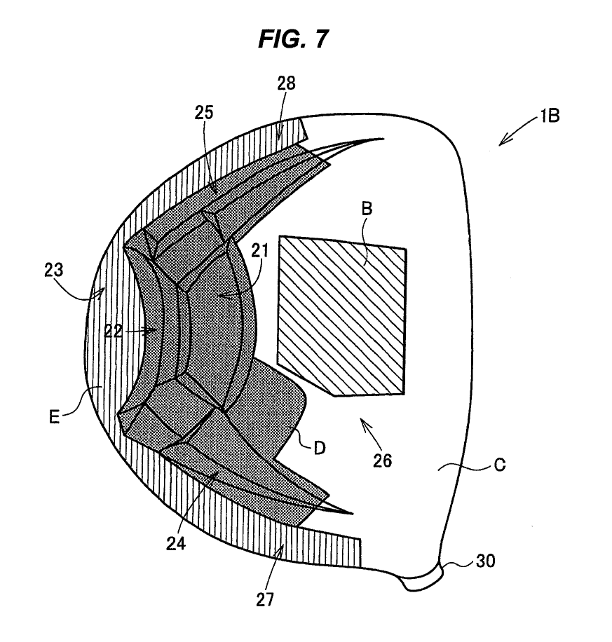

In the embodiment above, the area A is formed. However, as with a clubhead of a golf club according to an embodiment shown in FIG. 7, the thick area A is omitted and a thickness of an area corresponding to the area A in FIG. 3 may be equal to a thickness of an area C.

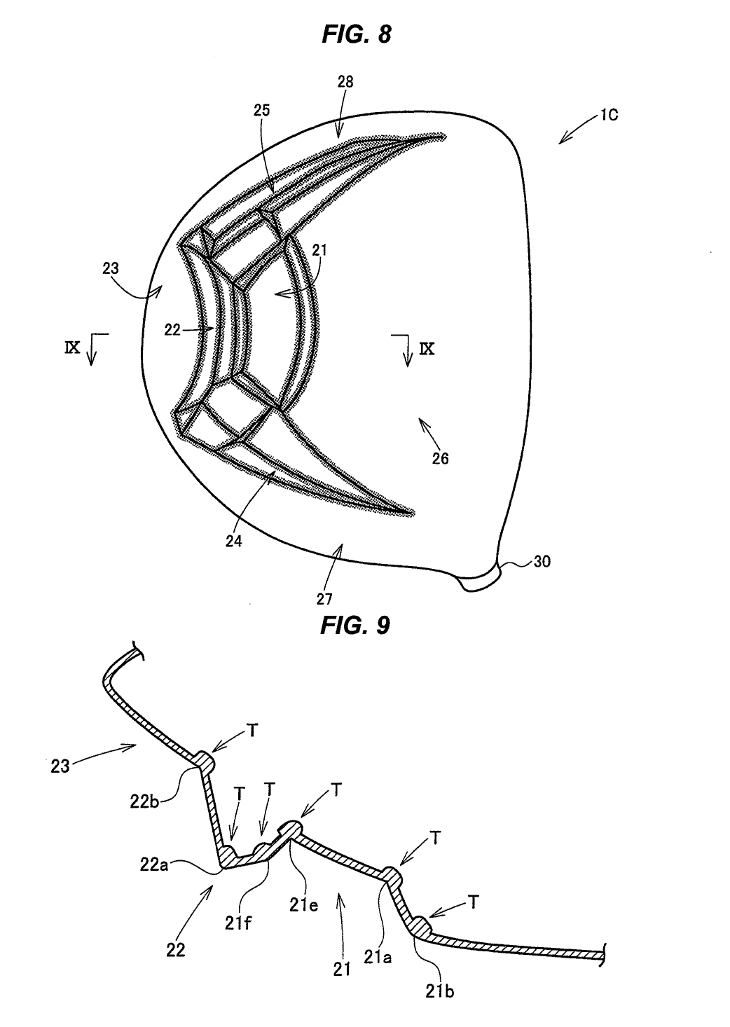

FIG. 8 is a bottom view of a clubhead 1C of a golf club according to a further different embodiment, and FIG. 9 is a sectional view taken along the line IX-IX in FIG. 8. In this embodiment, too, a recess portion 21 and projecting portions 22, 24, 25 are provided at a sole portion. Thicknesses at corner edge portions (projecting elongated corner portions, recess elongated corner portions and top ridge portions. For example, projecting elongated corner portions 21b, 21f, recess elongated corner portions 21a, 21e, 22b and a top ridge portion 22a in FIG. 9) of the recess portion 21 and the projecting portions 22, 24, 25 are made larger than thicknesses of peripheral portions so as to increase strengths at the corner edge portions. Reference character T in FIG. 9 denotes a portion where the thickness is so increased. In addition, portions shaded with fine dots in FIG. 8 denote areas where the portions T exist where the thickness is so increased. A thickness of the portion T is preferably 1.05 to 1.5 times and is more preferably 1.1 to 1.3 times a thickness of its peripheral portion. Additionally, a width of the portion T is preferably in the range of 0.5 to 4.0 mm and is more preferably in the range of 1.0 to 2.0 mm. The peripheral portions of the portions T are thinned through the aforesaid chemical polishing.

What is claimed is:

1. A clubhead of a golf club which is a metallic hollow clubhead comprising:
a face portion;
a crown portion;
a hosel portion; and
a lower part including a sole portion and side portions, wherein:
the hosel portion and the crown portion are welded to the lower part; and
the lower part is pressed out of a material plate and is thereafter subjected to a chemical polishing so that a thickness of the lower part varies by position.

2. The clubhead according to claim 1, wherein:
a projecting portion or a recess portion is provided at the sole portion; and
a thickness of the lower part at the projecting portion or the recess portion is larger than a thickness of the lower part at a central area of the sole portion.

3. The clubhead according to claim 2, wherein
the thickness of the lower part at the projecting portion or the recess portion is larger by 0.1 to 1.0 mm than the thickness of the lower part at the central area of the sole portion.

4. The clubhead according to claim 1, wherein
the thickness of the central area of the sole portion is smaller by not less than 0.2 mm than thicknesses of portions of the sole portion which lie before and after the central area.

5. The clubhead according to claim 1, wherein:
a projecting portion or a recess portion is provided at the sole portion; and
a thickness of a corner edge portion of the projecting portion or the recess portion is larger than a thickness of a peripheral portion thereof.

6. A method of manufacturing of a clubhead of a golf club which is a metallic hollow clubhead having a face portion, a crown portion, a hosel portion, and a lower part including a sole portion and side portions, the hosel portion and the crown portion being welded to the lower part, comprising:
manufacturing the lower part by pressing a lower part out of a material plate and thereafter subjecting the lower part to a chemical polishing so that a thickness of the lower part varies by position;
welding the face portion to the lower part; and
welding the hosel portion and the crown portion to the lower part and the face portion.

7. The method according to claim 6, wherein:
a thickness of the material plate of the lower part is in the range of 1.0 to 1.8 mm;
a projecting portion or a recess portion is formed through pressing; and
the lower part is subjected the chemical polishing so that a thickness of a central area of the sole portion is smaller by 0.1 to 1.0 mm than thicknesses of portions of the sole portion which lie before and after the central area.

8. The method according to claim 6, wherein:
a thickness of the material plate of the lower part is in the range of 1.0 to 1.8 mm;
a projecting portion or a recess portion is formed through pressing; and
a peripheral portion of the projecting portion or the recess portion is subjected to a chemical polishing so that a thickness of a corner edge portion of the projecting portion or the recess portion becomes larger than a thickness of the peripheral portion.
